(19) United States
(12) Patent Application Publication
(10) Pub. No.: US 2019/0194940 A1
(43) Pub. Date: Jun. 27, 2019

(54) ULTRATHIN POLYCARBONATE PANELS FOR SECURITY ISOLATION CELLS

(71) Applicant: PLASKOLITE MASSACHUSETTS, LLC, Columbus, OH (US)

(72) Inventors: Robert A. Pyles, Bethel Park, PA (US); James M. Lorenzo, Mars, PA (US)

(21) Appl. No.: 15/549,780

(22) PCT Filed: Aug. 19, 2016
(86) PCT No.: PCT/US2016/047786

§ 371 Date: Aug. 9, 2017

(51) Int. Cl. E04C 2/22; B32B 15/02; B32B 15/08; B32B 3/10; E04C 2/26; E04C 2/54; E04H 3/08; F41H 5/04

(52) U.S. Cl. CPC E04C 2/22; B32B 15/02; B32B 15/08; B32B 3/10; B32B 2607/00; E04C 2/54; E04H 3/08; F41H 5/0407; B32B 2307/732; E04C 2/26

(57) ABSTRACT

The present invention provides ultrathin polycarbonate panels for use in security isolation cells to provide a transparent and secure barrier between a prisoner and a guard, where the barrier passes flammability test ASTM E-84 Class A. The panel comprises at least one polycarbonate sheet having a thickness between 0.25 mm and 1 mm. Panels may optionally include a metal support and a frame, and the frame may overbite (edge bite) a portion of the polycarbonate panel, and all points of the polycarbonate panel may be located within four frame widths of the frame.

### CROSS REFERENCE TO RELATED APPLICATIONS

This application is a national stage application under 35 U.S.C. § 371 of PCT/US2016/047786, filed August 19, 2016, which this application claims the benefit of and which is incorporated by reference herein.

### FIELD OF THE INVENTION

The present invention relates to polycarbonate panels for security isolation cells.

### SUMMARY OF THE INVENTION

In one embodiment of the invention, a panel comprises a polycarbonate sheet having a thickness from 0.25 mm to 1 mm, and metal support, which may be a wire screen, wire mesh, thin metal strips in a lattice configuration or bars. The metal support may be positioned to provide support to the polycarbonate sheet, in case of an impact upon the polycarbonate sheet. This embodiment of the invention may further comprise a frame, wherein the polycarbonate sheet is secured to the frame.

In another embodiment of the invention, a panel comprises a polycarbonate sheet having a thickness from 0.25 mm to 1 mm, and a frame to which the panel is secured. In a different embodiment, the polycarbonate sheet has a thickness of 0.50 mm to 0.75 mm.

In yet another embodiment of the invention, a majority of points of the polycarbonate sheet are located at a distance from the frame, or no greater than 4 times the width of the frame. In still another embodiment, all points of the polycarbonate sheet are located at a distance from the frame, or no greater than 4 times the width of the frame.

In an embodiment of the invention different from the ones disclosed above, the polycarbonate sheet has a molecular weight of 25,000 to 36,000 g/mol. In another embodiment, the molecular weight is 28,000 to 34,000 g/mol. In still another embodiment, the molecular weight is 30,000 to 32,000 g/mol.

In another embodiment not yet disclosed, the polycarbonate sheet has two sides and the frame comprises two plates that are pressed against each of the two sides. In a different embodiment, the plates comprise metal. In yet another embodiment, a portion of the polycarbonate sheet is held within a majority of the frame. In still another embodiment, a portion of the polycarbonate is held completely within the frame.

In a separate embodiment, a security isolation cell comprises a panel described above.

### BRIEF DESCRIPTION OF THE FIGURES

The present invention will now be described for purposes of illustration and not limitation in conjunction with the figures, wherein:

FIG. 1 shows a front view of a polycarbonate panel, having a polycarbonate sheet and a frame attached to it;

FIG. 2 shows a back view of the polycarbonate panel of FIG. 1;

FIG. 3 shows a perspective view of the outside of a security cell having several polycarbonate panels of another embodiment of the invention;

FIG. 4 shows a cut-away view of one mounting method of a polycarbonate panel of the invention;

FIG. 5 shows a cut-away view of another mounting method of a polycarbonate panel of the invention;

FIG. 6 shows a perspective view of the outside of a security cell wall, including several polycarbonate panels of another embodiment of the invention; and

FIG. 7 shows a perspective view of the inside of the security cell wall of FIG. 6.

### DESCRIPTION OF THE INVENTION

Several different panels are described herein, which may be attached as part of a security isolation/holding cell. The panels of the present invention are substantially transparent, to allow a guard to look into the security isolation cell at any time, and view the inhabitants and contents of the cell. In addition, the panels have sufficient strength to keep the prisoner, and anything the prisoner may throw, inside of the cell, should the prisoner try to breach the cell, or otherwise throw things outside of the cell. Furthermore, the panel deters the prisoner from accessing metal wires, such as those that often constitute parts of or the entirety of security cell walls and doors. Finally, the panels should pass flammability test ASTM E-84 Class A.

The panels are substantially transparent, so that a guard may look inside of a security isolation cell without having to open a door. The panels of the present invention comprise polycarbonate sheets. Suitable polycarbonate resins for preparing the sheets useful in constructing panels of the present invention are homopolycarbonates and copolycarbonates, both linear or branched resins and mixtures thereof.

The polycarbonates have a weight average molecular weight of preferably 10,000 to 200,000, more preferably 20,000 to 80,000 and their melt flow rate, per ASTM D-1238 at 300° C., is preferably 1 to 65 g/10 min., m ore preferably 2 to 35 g/10 min. They may be prepared, for example, by the known diphasic interface process from a carbonic acid derivative such as phosgene and dihydroxy compounds by polycondensation (See, German Offenlegungsschriften 2,063,050; 2,063,052; 1,570,703; 2,211,956; 2,211,957 and 2,248,817; French Patent 1,561,518; and the monograph by H. Schnell, “Chemistry and Physics of Polycarbonates”, Interscience Publishers, New York, N.Y., 1964).

In the present context, dihydroxy functional compounds suitable for the preparation of the polycarbonates of the invention conform to the structural formulae (1) or (2) below.

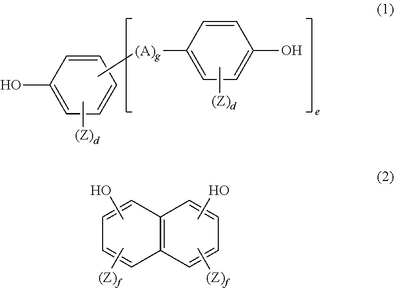

wherein

A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, 'SO— or —SO₂ or a radical conforming to (3)

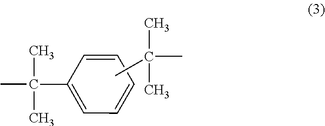

e and g both denote the number 0 to 1;

Z denotes F, Cl, Br or C1-C4-alkyl and if several Z radicals are substituents in one aryl radical, they may be identical or different from one another;

d denotes an integer of from 0 to 4; and

f denotes an integer of from 0 to 3.

Among the dihydroxy compounds useful in the practice of the invention are hydroquinone, resorcinol, bis-(hydroxyphenyl)-alkanes, bis-(hydroxyl-phenyl)-ethers, bis-(hydroxyphenyl)-ketones, bis-(hydroxyl-phenyl)-sulfoxides, bis-(hydroxyphenyl)-sulfides, bis-(hydroxyphenyl)-sulfones, and α,α-bis-(hydroxyphenyl)-diisopropylbenzenes, as well as their nuclear-alkylated compounds. These and further suitable aromatic dihydroxy compounds are described, for example, in U.S. Pat. Nos. 5,401,826, 5,105,004; 5,126,428; 5,109,076; 5,104,723; 5,086,157; 3,028,356; 2,999,835; 3,148,172; 2,991,273; 3,271,367; and 2,999,846, the contents of which are incorporated herein by reference.

Further examples of suitable bisphenols are 2,2-bis-(4-hydroxyphenyl)-propane (bisphenol A), 2,4-bis-(4-hydroxyphenyl)-2-methyl-butane, 1,1-bis-(4-hydroxyphenyl)-cyclohexane, α,α′-bis-(4-hydroxy-phenyl)-p-diisopropylbenzene, 2,2-bis-(3-methyl-4-hydroxyphenyl)-propane, 2,2-bis-(3-chloro-4-hydroxyphenyl)-propane, 4,4′-dihydroxy-diphenyl, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxy-phenyl)-sulfoxide, bis-(3,5-dimethyl-4-hydroxyphenyl)-sulfone, dihydroxy-benzophenone, 2,4-bis-(3,5-dimethyl-4-hydroxyphenyl)-cyclohexane, α,α′-bis-(3,5-dimethyl-4-hydroxyphenyl)-p-diisopropyl-benzene and 4,4′-sulfonyl diphenol.

Examples of particularly preferred aromatic bisphenols are 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxy-phenyl)-3,3,5-trimethylcyclohexane. The most preferred bisphenol is 2,2-bis-(4-hydroxyphenyl)-propane (bisphenol A).

The polycarbonates useful in producing the panel of the invention may entail in their structure units derived from one or more of the suitable bisphenols.

Among the resins suitable in the practice of the invention are phenolphthalein-based polycarbonate, copolycarbonates and terpolycarbonates such as are described in U.S. Pat. Nos. 3,036,036 and 4,210,741, both of which are incorporated by reference herein. This incorporation is preferably specific with respect to the structures, constituents and ratio of constituents of the phenolphthalein-based polycarbonates, copolycarbonates and terpolycarbonates.

The polycarbonates useful in preparing the panel of the invention may also be branched by condensing therein small quantities, e.g., 0.05 to 2.0 mol % (relative to the bisphenols) of polyhydroxyl compounds. Polycarbonates of this type have been described, for example, in German Offenlegungsschriften 1,570,533; 2,116,974 and 2,113,374; British Patents 885,442 and 1,079,821 and U.S. Pat. No. 3,544,514, which is incorporated herein by reference. The following are some examples of polyhydroxyl compounds which may be used for this purpose: phloroglucinol; 4,6-dimethyl-2,4,6-tri-(4-hydroxy-phenyl)-heptane; 1,3,5-tri-(4-hydroxyphenyl)-benzene; 1,1,1-tri-(4-hydroxyphenyl)-ethane; tri-(4-hydroxyphenyl)-phenyl-methane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methyl-phenol; 2,4-dihydroxybenzoic acid; 2-(4-hydroxy-phenyl)-2-(2,4-dihydroxy-phenyl)-propane and 1,4-bis-(4,4′-dihydroxytri-phenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in U.S. Pat. Nos. 3,028,365; 2,999,846; 3,153,008; and 2,991,273 which are incorporated herein by reference.

The preferred process for the preparation of polycarbonates is the interfacial polycondensation process. Other methods of synthesis in forming the polycarbonates of the invention, such as disclosed in U.S. Pat. No. 3,912,688, incorporated herein by reference, may be used. Suitable polycarbonate resins are available in commerce, for instance, from Covestro LLC, Pittsburgh, Pa., under the MAKROLON trademark. In one embodiment, polycarbonate having a high molecular weight is used; in this or in another embodiment a polycarbonate or polycarbonate blend is used that has a low amount of additives, or even none at all. Examples of such polycarbonates include those having molecular weights in the range of 25,000 to 36,000 g/mol, preferably 28,000 to 34,000 g/mol and most preferably 30,000 to 32,000 g/mol. One such brand is Makrolon© 3100, sold by Covestro LLC, of Pittsburgh, Pa.

The most common technique for measuring the molecular weight of a polymer is a variant of high-pressure liquid chromatography (HPLC) known by the interchangeable terms of size exclusion chromatography (SEC) and gel permeation chromatography (GPC). This technique involves forcing a polymer solution at pressures of up to several hundred bar, through a stationary matrix of cross-linked polymer particles packed into a column. In contrast to large molecular weight species, lower molecular weight species enter the voids in the column packing material more easily. Therefore the low molecular weight species spend more time in these voids, resulting in an increase of their retention times inside the column. On the other hand, larger molecular weight species spend little, if any time in these voids and elute from the column more quickly. Thus, polymeric molecules with significantly different molecular weights can be separated in this manner. All columns have a particular range of polymer molecular weights that can be separated. The use of low polydispersity polymer standards allows the packed column to be calibrated and the column retention times to be correlated with the polymer molecular weight.

By far the most common detector used for size exclusion chromatography is the differential refractive index detector that measures the change in refractive index of the solvent due to the presence of a polymeric species as a function of time. One such detector is manufactured by Knauer Wissenschafliche Gerate GmbH, Berlin, Germany, which manufactures differential refractive index detectors under the RefractoMax brand. This detector is concentration sensitive and molecular weight insensitive so it is ideal for a single detector GPC system, allowing for generation of molecular weight curves.

The polycarbonate is used in the form of sheets or films in the inventive panel. Suitable polycarbonate sheets are available under the MAKROFOL trademark, also from Covestro LLC. One characteristic of the panels of the present invention, is that very thin, or ultrathin, polycarbonate sheets are used. The thickness of the polycarbonate sheets is preferably between 10 and 40 mils (0.010 inches-0.040 inches, or 0.25 mm-1 mm), most preferably between 20 and 30 mils (0.020 inches-0.030 inches, or 0.50 mm-0.76 mm).

While ultrathin polycarbonate sheets are known, their use thus far has been limited to applications where an impact is not expected, such as in graphic arts applications, or automobile instrument panel clusters. That is because ultrathin polycarbonate sheet is known to be not as robust to impacts and breakage when compared to thicker sheets. In applications where an impact is expected, such as in an exterior automotive part, a polycarbonate with a much higher thickness is used.

It has been found that only ultrathin polycarbonate sheets, such as polycarbonate sheets having a thickness of 30 mils (0.030 inches and 0.76 mm), achieve Class A of ASTM E84-03 test, Standard Method of Test for Surface Burning Characteristics of Building Materials.” This method is believed to be comparable to UL 723, ANSI/NFPA No. 255, and UBC No. 8-1. To meet ASTM E-84 Class A, a material must have both a flame spread of 25 or less and a smoke developed index of 450 or less. The test includes measuring flame spread and smoke developed index. The flammability test results for various polycarbonate thicknesses are as follows:

TABLE 1

| | PC Thickness | | Smoke Developed |
|---|---|---|---|
| E-84 Class | (mils) | Flame Spread | Index |
| A | 30 | <25 | <450 |
| B | 60 | >25-<75 | <450 |
| N/A | 118 | 70 | 455 |
| B | 236 | 60 | 415 |
| N/A | 500 | 48 | 1380 |

As noted in Table 1 above, the polycarbonate sheet having a thickness of 30 mils has both a flame spread of less than 25, and a smoke developed index of less than 450, thus being the only sheet tested above to meet the requirements of ASTM E-84 Class A.

However, to overcome the drawback of the lack of strength of thin polycarbonate sheets, strength can be imparted to the sheet, in two different ways. First, metal supports may be used behind the polycarbonate sheet, such as a wire screen, a wire mesh, thin metal strips or bars, which may or may not be in a lattice configuration. In addition, this embodiment has the added benefit of protecting a prisoner in a security detention cell from being bruised or cut on the metal or from accessing the metal to harm himself or others.

Another method to impart strength to the polycarbonate sheet is to use a frame to secure the sheet, where the frame preferably has metal pressed against both sides of the polycarbonate sheet, and has a sufficient overbite (edge bite), such that the metal frame is able to add strength when compared with the sheet alone. In this embodiment, the frame overbite (edge bite) should overlap the polycarbonate sheet, such that the frame overbite (edge bite) engages the polycarbonate sheet sufficiently to avoid tearing of polycarbonate sheet from the frame, or in a preferred embodiment all of the frame overbites (edge bite) engages the polycarbonate sheet, to enable the frame to provide sufficient impact support. This frame concept also allows for easy replacement of a single, damaged panel as opposed to replacing the entire wall.

Furthermore, the frame is preferably close enough to all points on the polycarbonate sheet to provide it with sufficient strength to survive an impact from a heavy object or person trying to penetrate it. In this embodiment, most points on the polycarbonate sheet are no more than 4 frame widths away from the frame. For example, if the frame width is 1½ inch (3.8 cm), then the majority of points on the polycarbonate sheet, that are not part of the overbite (edge bite) underneath the frame, should be no more than 6 inches (15.2 cm) from the frame. In a preferred embodiment, all of the points of the polycarbonate sheet are within four frame widths of the frame.

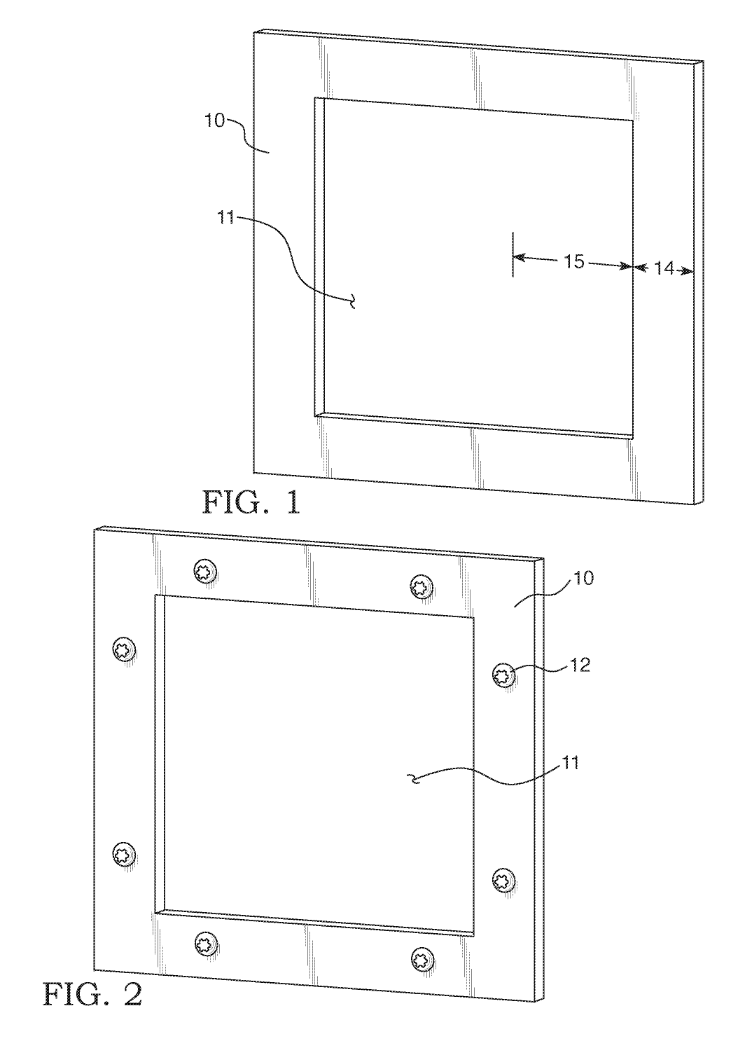

As shown in FIG. 1, in one embodiment a panel comprises frame 10, which is attached to a polycarbonate sheet 11. The secure side of the panel is shown, which would be accessible to a prisoner in a security isolation cell. Accordingly, the bolts are unable to be accessed from this side. The frame 10 has a width 14. Distance 15 is four times the width 14, and is measured from the closest edge of the frame. Most points on polycarbonate sheet 11 lay within distance 15, while some points may lay beyond distance 15. FIG. 2 is back view from outside the holding cell of the panel of FIG. 1. In this view, bolts 12 are visible. Bolts 12 fit through frame 10, and through holes in polycarbonate sheet 11.

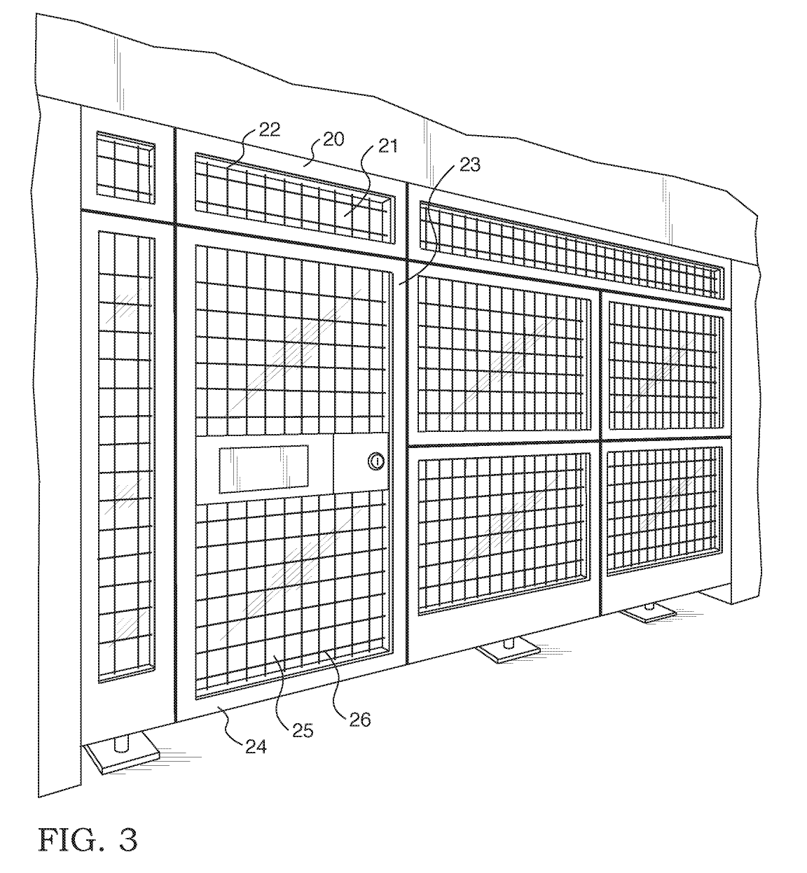

FIG. 3 shows a security cell wall comprising several panels of another embodiment, wherein each panel comprises a frame 20, a polycarbonate sheet 21 and metal support 22. Door 23 is also shown to comprise a panel having frame 24, polycarbonate sheet 25 and metal supports 26 The panels are arranged, and attached to one another, to form a wall that is substantially transparent, such that a guard may view the contents of the cell at any time without opening door 23.

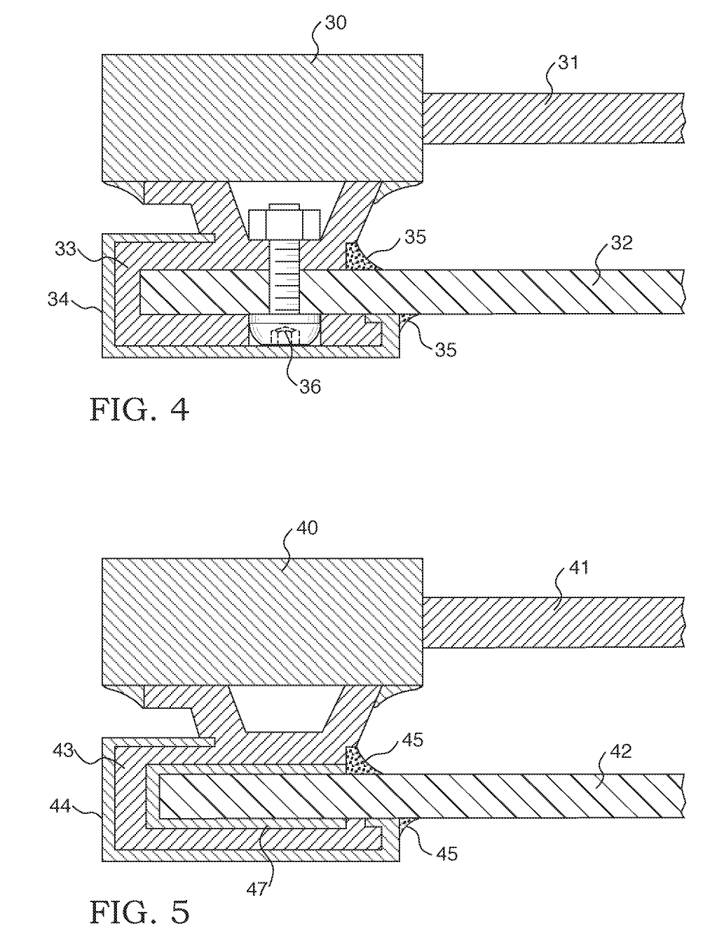

FIG. 4 shows one method of attaching polycarbonate sheet 32 to existing security cell wall 30 having metal supports 31. Polycarbonate sheet 32 fits inside frame 33, and is held in place by bolt 36, which fits through holes in frame 34 and polycarbonate sheet 32. Trim 34 fits around frame 33, preventing an occupant of the security holding cell from gaining access to bolt 36. Optional Sealant 35 is preferably a polymer which adheres to polycarbonate sheet 32, frame 33 and trim 34 and is chemically compatible with the polycarbonate sheet. One such sealant is Dow Corning 995, a silicone structural sealant, manufactured by the Dow Corning Company, Midland, Mich. Dow Corning 995 offers the following benefits: high tensile and tear strength; remains flexible long-term; weather, ultraviolet radiation, and temperature extremes resistant; adheres to glass and most window frame materials used for hurricane or impact rated windows and doors; and when cured is chemically compatible with polycarbonate sheet.

FIG. 5 shows another method of attaching polycarbonate sheet 42 to existing security cell wall 40 having metal supports 41. Polycarbonate sheet 42 fits inside frame 43, and is held in place by polymer cover 47, which may be pre-bonded to polycarbonate sheet 42. Polymer cover 47 may be made of polycarbonate or another polymer that is easily bonded to polycarbonate sheet 42. Trim 44 fits around frame 43. Sealant 45 is preferably a polymer which adheres to polycarbonate sheet 42, frame 43 and trim 44.

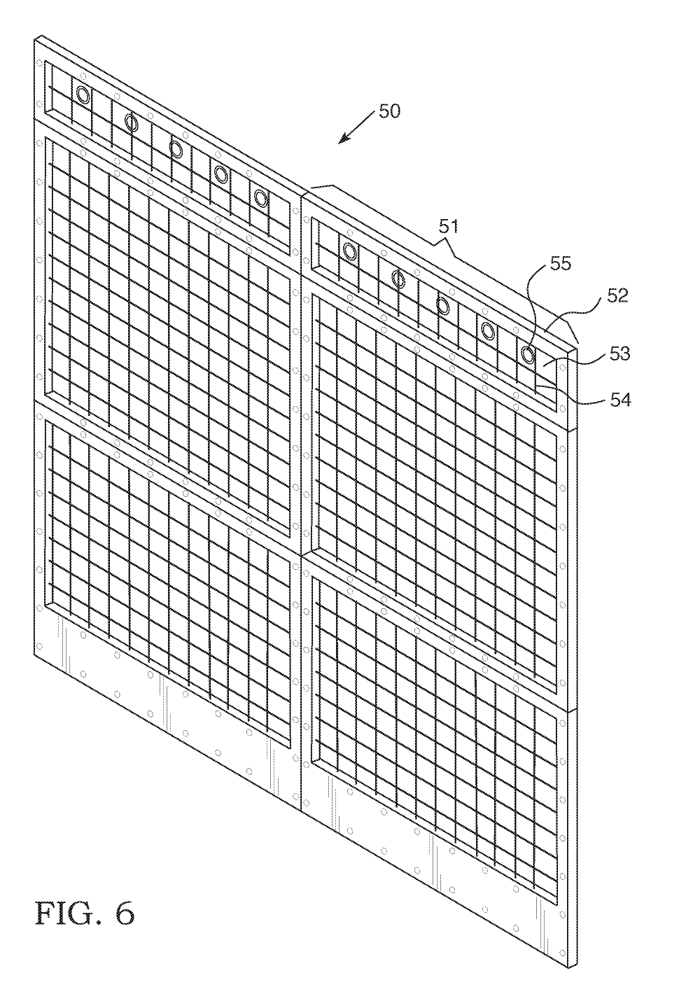

FIG. 6 shows the secure side (the cell occupant side) of security cell wall 50, which is comprised of several panels, including panel 51, which comprises frame 52, polycarbonate sheet 53 and metal supports 54. Polycarbonate sheet 53 also includes one or more holes 55 through which air may pass in and out of security cell wall 50 to help supply and circulate ventilation through the holding cell. It should also be noted that the bolts which secure the panels to the cell walls, are not readily accessible to the holding cell occupants.

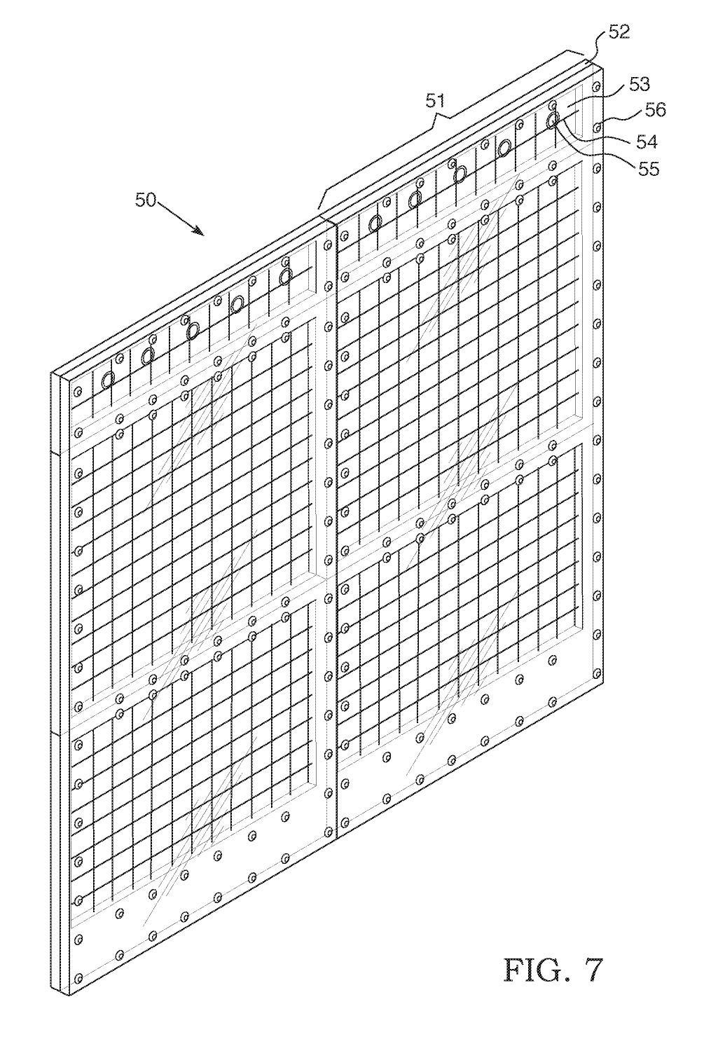

FIG. 7 shows the unsecured side (or guard side) of security cell wall 50 of FIG. 6. FIG. 7 also shows panel 51, comprising frame 52, polycarbonate sheet 53, metal supports 54, holes 55 and bolts 56.

The following preferred embodiments of the present invention are summarized:

Item 1. A panel comprising:
a polycarbonate sheet; and
metal support;
wherein the polycarbonate sheet has a thickness of 0.25 mm-1 mm.

Item 2. The panel of Item 1, wherein the metal support is wire screen, wire mesh, thin metal strips in a lattice configuration or bars.

Item 3. The panel of Items 1 or 2, wherein the metal support is positioned to provide support to the polycarbonate sheet, in case of an impact upon the polycarbonate sheet.

Item 4. The panel of Items 1-3, further comprising a frame, wherein the polycarbonate sheet is secured to the frame.

Item 5. A panel comprising:
a polycarbonate sheet; and
a frame;
wherein the polycarbonate sheet has a thickness of 0.25 mm-1 mm, and
wherein the polycarbonate sheet is secured to the frame.

Item 6. The panel of any of the preceding items, wherein the polycarbonate sheet has a thickness of 0.50 mm-0.75 mm.

Item 7. The panel of any of the preceding items, wherein the majority of points of the polycarbonate sheet are located at a distance from the frame, of no greater than 4 times the width of frame.

Item 8. The panel of Item 7, wherein all points of the polycarbonate sheet are located at a distance from the frame, of no greater than 4 times the width of frame.

Item 9. The panel of any of the preceding items, wherein the polycarbonate sheet has a molecular weight of 25,000 to 36,000 g/mol.

Item 10. The panel of Item 9, wherein the polycarbonate sheet has a molecular weight of 28,000 to 34,000 g/mol.

Item 11. The panel of Item 9, wherein the polycarbonate sheet has a molecular weight of 30,000 to 32,000 g/mol.

Item 12. The panel of Items 4-11 wherein the polycarbonate sheet has two sides and the frame comprises two plates that are pressed against each of the two sides of the polycarbonate sheet.

Item 13. The panel of Item 12 wherein the plates comprise metal.

Item 14. The panel of Items 12 or 13 wherein a portion of the polycarbonate sheet is held within a majority of the frame.

Item 15. The panel of Item 14, wherein a portion of the polycarbonate sheet is held completely within the frame.

Item 16. A security isolation cell comprising a panel of any of the preceding items.

1-16. (canceled)

17. A panel comprising:
a polycarbonate sheet; and
metal support;
wherein the polycarbonate sheet has a thickness of 0.25 mm-1 mm.

18. The panel of claim 17, wherein the metal support is selected from the group consisting of a wire screen, wire mesh, thin metal strips in a lattice configuration and bars.

19. The panel of claim 17, wherein the metal support is positioned to provide support to the polycarbonate sheet, in case of an impact upon the polycarbonate sheet.

20. The panel of claim 17, further comprising a frame, wherein the polycarbonate sheet is secured to the frame.

21. The panel of claim 17, wherein the polycarbonate sheet has a thickness of 0.50 mm-0.75 mm.

22. The panel of claim 17, wherein the majority of points of the polycarbonate sheet are located at a distance from the frame, of no greater than 4 times the width of frame.

23. The panel of claim 17, wherein all points of the polycarbonate sheet are located at a distance from the frame, of no greater than 4 times the width of frame.

24. The panel of claim 17, wherein the polycarbonate sheet has a molecular weight of 25,000 to 36,000 g/mol.

25. The panel of claim 24, wherein the polycarbonate sheet has a molecular weight of 28,000 to 34,000 g/mol.

26. The panel of claim 25, wherein the polycarbonate sheet has a molecular weight of 30,000 to 32,000 g/mol.

27. The panel of claim 20 wherein the polycarbonate sheet has two sides and the frame comprises two plates that are pressed against each of the two sides of the polycarbonate sheet.

28. The panel of claim 27 wherein the plates comprise metal.

29. The panel of claim 27 wherein a portion of the polycarbonate sheet is held within a majority of the frame.

30. The panel of claim 29, wherein a portion of the polycarbonate sheet is held completely within the frame.

31. A security isolation cell comprising a panel of claim 17.

32. A panel comprising:
a polycarbonate sheet; and
a frame;
wherein the polycarbonate sheet has a thickness of 0.25 mm-1 mm, and
wherein the polycarbonate sheet is secured to the frame.

33. The panel of claim 32, wherein the polycarbonate sheet has a thickness of 0.50 mm-0.75 mm.

34. The panel of claim 32, wherein the majority of points of the polycarbonate sheet are located at a distance from the frame, of no greater than 4 times the width of frame.

35. The panel of claim 34, wherein all points of the polycarbonate sheet are located at a distance from the frame, of no greater than 4 times the width of frame.

36. The panel of claim 32, wherein the polycarbonate sheet has a molecular weight of 25,000 to 36,000 g/mol.

37. The panel of claim 36, wherein the polycarbonate sheet has a molecular weight of 28,000 to 34,000 g/mol.

38. The panel of claim 37, wherein the polycarbonate sheet has a molecular weight of 30,000 to 32,000 g/mol.

39. The panel of claim 32 wherein the polycarbonate sheet has two sides and the frame comprises two plates that are pressed against each of the two sides of the polycarbonate sheet.

40. The panel of claim 39 wherein the plates comprise metal.

41. The panel of claim 39 wherein a portion of the polycarbonate sheet is held within a majority of the frame.

42. The panel of claim 39, wherein a portion of the polycarbonate sheet is held completely within the frame.

43. A security isolation cell comprising a panel of claim 32.
